(19) United States
(12) Patent Application Publication
(10) Pub. No.: US 2013/0073359 A1
(43) Pub. Date: Mar. 21, 2013

(54) SYSTEM AND METHOD FOR RECEIVING AND APPORTIONING FEES IN AN ONLINE ENVIRONMENT

(71) Applicant: Jared L. Caplan, Dallas, TX (US)

(72) Inventor: Jared L. Caplan, Dallas, TX (US)

(21) Appl. No.: 13/234,140

(22) Filed: Sep. 15, 2011

(51) Int. Cl. G06Q 30/00

(52) U.S. Cl. 705/14.16

(57) ABSTRACT

In one embodiment, a method is provided for receiving and apportioning fees in an online environment comprising a plurality of user accounts of an organization. According to a first step, the organization receives a first payment, which includes one portion for hosting the first user account, a second portion for credits that may be used for online activity, and a third portion for first user discounts that may be used to recruit additional users. In a next step, the organization receives a second payment from a second user recruited by the first user. In an additional step, the organization automatically credits the first user's account in an amount equal to the first user discount redeemed by the second user.

### TECHNICAL FIELD OF THE INVENTION

The present invention relates generally to art competitions that benefit artists and charities and, more particularly, to receiving and apportioning fees in an online environment.

### BACKGROUND OF THE INVENTION

A major problem faced by charitable organizations is how to maximize the charitable impact of each donation they receive. Charities determine to match or exceed the efficiency of other charities to attract potential donors and to meet the efficiency expectations of current donors. However, charities struggle with geographical boundaries due to volunteer shortages, limited resources and travelling expenses. For example, Big Brothers Big Sisters is a charity that began in New York City and expanded across the United States and into twelve countries. In each location, to meet efficiency expectations, Big Brothers Big Sisters selects local volunteers to serve as caring role models and mentors for local children in need.

Similarly, a major problem faced by artists is how to gain widespread support and recognition for their artwork. Artists often credit their success to mentors who supported them and their local community. However, the appeal of a particular artwork may not be fully realized and appreciated in an artist's local community To gain appeal, artists may seek to increase their exposure regionally through regional art competitions, nationally or even internationally.

The introductions of the internet and worldwide web have unleashed new opportunities for charities or artists to gain recognition. Today, artists gain recognition for their artwork among friends and friends-of-friends using online art communities, social networking websites and other communication media. Volunteers, donors, fans and talent scouts can now gain unparalleled access to their favorite charities and artists and discover new ones. The proliferation of the internet and other communication networks permits rapid and effective communications between any number and type of organizations, artists, charities, fans, sponsors, etc. Moreover, it is well known that websites generate advertising revenues when users of websites click on advertisements. The greater the number of clicks on advertisements a website generates, the greater the amount of advertising revenues. However, existing technology for organizations seeking to promote artists or give to charities has yet to fully exploit current and anticipated advances.

### SUMMARY OF THE INVENTION

In accordance with the present invention, techniques for strategic management of entry fees to art competitions are provided. In one embodiment, a method for receiving and apportioning fees in an online environment is provided. The method includes receiving a first payment to register for a first user account. The first payment includes a first portion in exchange for hosting the first user account; a second portion in exchange for one or more first user credits for online activity; and a third portion in exchange for one or more first user discounts for recruiting one or more additional users of the online environment. The method also includes receiving a second payment recruited by the first user to register for a second user account and automatically crediting at least one other user account in an amount comprising at least a portion of one or more of the first user discounts redeemed by the second user, as discussed below. In another embodiment, the step of automatically crediting at least one other user account in an amount corresponding to at least a portion of particular ones of the one or more first user discounts, such as those redeemed to register a user account, includes automatically crediting the first user account. In a further embodiment, the second payment includes a fourth portion for payment of at least one referral fee to a referring user such as a referring charity.

Particular embodiments of the invention may provide one or more technical advantages. As an example, particular embodiments may provide new systems and methods for ranking art in an online art competition based on votes submitted online from fans. As another example, particular embodiments may provide new systems and methods for recruiting art fans using social networking connections. As a further example, particular embodiments may provide new systems and methods for promoting art using a bracket competition format for each of multiple rounds of a competition.

Other technical advantages of the present invention will be readily apparent to one skilled in the art from the following figures, descriptions and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is made to the following description, taken in conjunction with the accompanying drawings, in which:

FIG. 1 illustrates an exemplary system for generating artist successes and charitable contributions;

FIG. 2a illustrates an exemplary allocation of revenues of an organization among artists, charities, champions and the organization;

FIG. 2b illustrates an exemplary allocation of revenues of an organization among artist successes, charitable contributions and organization revenues;

FIG. 3 illustrates an exemplary art ranking engine for ranking art in an art competition;

FIG. 4 illustrates an exemplary table of entry fees to an art competition;

FIG. 5 illustrates an exemplary method for generating artist successes and charitable contributions by leveraging social networking connections; and

FIG. 6 illustrates an exemplary method for generating artist successes and charitable contributions.

### DETAILED DESCRIPTION OF THE INVENTION

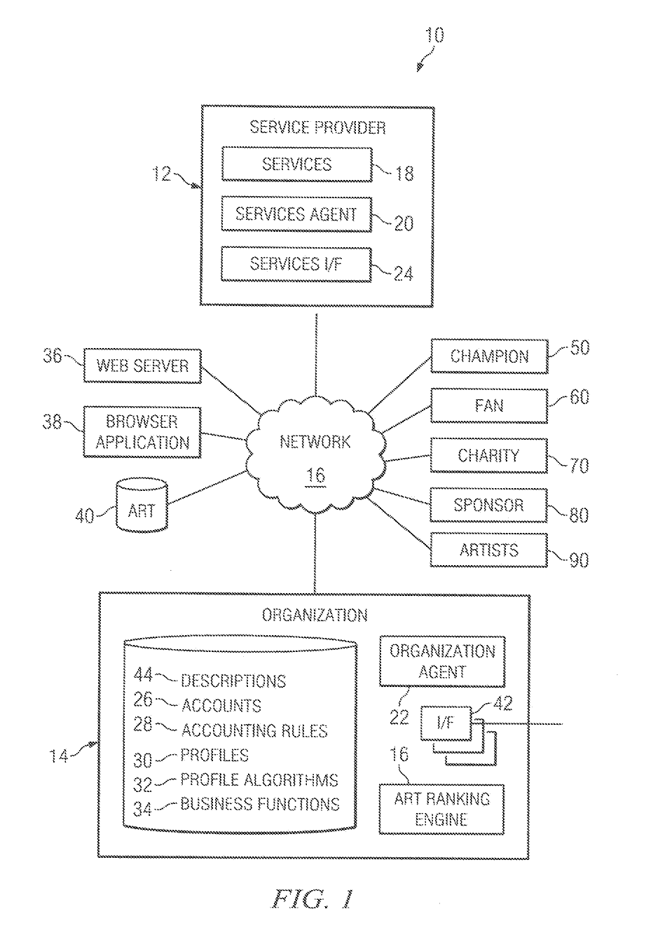

FIG. 1 illustrates a system, indicated generally at 10, that includes one or more art service providers 12 and one or more organizations 14 interconnected by a communications network 16. Art service providers 12 offer art services 18, such as art uploading, art creation and/or art viewing, potentially using service agents 20 to facilitate offering of art services 18 to one or more organizations 14 and a plurality of users of organizations 14. According to particular embodiments, organization 14 may include one or more organization agents 22 to facilitate interaction between users and art services 18 and/or to accomplish one or more business functions 34 of organization 14. According to particular embodiments, organization agent 22 interacts with other elements of system 10 to accomplish business functions 34 of organization 14.

System 10 may include any number and type of art service providers 12 offering various art services 18. Each art service provider 12 represents any suitable collection of components capable of offering access to art 40 and art services 18 through defined services interfaces 24. According to particular embodiments, art service providers 12 offer machine readable services interfaces 24 that enable structured queries to access and interact with art 40 for purposes of obtaining art services 18. For example, a particular art service provider 12 may provide access to and interaction with a particular one or multiple of local, regional or national art competitions. As another example, a particular art service provider 12 may provide results of a search engine that include art 40 and may also rank search results based on ranking criteria, including ranking criteria defined by organization 14. As another example, a particular art service provider 12 may provide results of an analysis of similarities such as musical similarities or genre similarities, that include results relating to art 40, and may rank those results based on at least some ranking criteria, including ranking criteria defined by organization 14. As another example, a particular art service provider 12 may provide access to and interaction with an art uploading system that enables users to upload multiple digital media files containing at least a portion or graphical representation of art online To provide these functions, art service providers 12, potentially using art services agents 20, may support any number of features and interfaces to features. According to particular embodiments, art service providers 12 identify particular features and techniques for interfacing with those particular features of art services 18 using services interfaces 24. According to particular embodiments, art service providers 12 operate and advertise according to publicly developed and available standards for communications. System 10 contemplates that art service providers 12 may include any number and/or type of components, such as components for communication with art services agents 20, organization 14, and/or organization agents 22.

System 10 may include any number and type of art services 18. For example, system 10 may include art services 18 for creating, supplying and viewing art, search engine services, interactive entertainment services, payment, registration, login, account management, mobile applications for interacting with art, and other appropriate business services. Each feature within an art service 18 may provide any suitable level of sophistication. For example, a viewing feature may support sophisticated uploading and preview formats and processes using a large number of viewing criteria. As another example, a video uploading feature may require input of specified video content into a particular one of multiple video fields, such as a video content placeholder for specified video content among other video content. According to particular embodiments, art services 18 operate using publicly developed and available standards for digital media formats and communications, such as picture and video formats, and comply with governing laws, such as those governing copyright for original works of art and freedom of information. Various art services 18 may be standards driven, corporation driven, dynamically created or otherwise specified to support appropriate interactions between art services 18 and organizations 14 and/or users of organization 14.

System 10 may include any number and/or type of organizations 14 that enable interaction with users of an online environment, such as an online environment or an online environment for accessing art, and other elements of system 10. Organization 14 represents any suitable combination and arrangement of components facilitating collection and storage of information, including various algorithms and instructions, relating to an online environment and operation of an online environment. Organization 14, potentially through one or more organization agents 22, collects and stores this information and operates an online environment using browser application 38 and a plurality of web pages hosted by and/or accessed through Web server 36.

Organization 14 supports discovery and interaction with art services 18 to investigate and achieve business functions 34 of organization 14. In addition or as an alternative, art services 18 may support discovery and interaction with organization 14 and/or various users of organization 14, for example, using social networking connections or other databases storing contact information of users. For example, organization 14 may identify a particular art service 18 for uploading video content and then interact with the particular art service 18 to negotiate or otherwise establish payment terms and/or conditions. Users of organization 14 may then link to art services 18 from various web pages of organization 14 and use the identified art service 18. For example, for video uploading, organization 14 may supply selected video content, user profiles, video uploading format and pricing information to enable art service 18 to fulfill video uploading and payment processing for video uploading. Within organization 14, organization agent 22 handles dynamic discovery and/or interaction by interfacing with art service providers 12 and/or art services 18 and other elements of system 10. In addition to actively seeking art services 18 to fulfill business functions 34, organization 14 and/or organization agent 22 may advertise various aspects of business functions 34 and permit art service providers 12 to generate new users and user accounts on behalf of or in conjunction with organization 14. System 10 contemplates that organization 14 may include any number and/or type of components, such as components for communication with art services agents 20, organization 14, and/or organization agents 22.

According to particular embodiments, particular ones of organization agents 22 may represent rock & roll bands, musicians, animators, character creators, movie directors, actors, and/or any other individual, agent, company or association of individuals or computers acting on their behalf to generate art 40 for organization 14, including video assets of organization 14 for use in an art competition.

As illustrated, system 10 includes at least one web server 36 in communications over communications network 16. For purposes of illustration, the disclosed embodiment is adapted to be used with the Internet serving as the computer network. However, the subject invention is easily modified and adapted for use on other forms of computer networks, such as an intranet, and/or mobile networks, according to communication standards such as 3G networks, 4G networks, etc. Web server 36 includes an applet therein which generates a graphical user interface that displays an identifier and a link to register with organization 14 using the identifier. Web server 36 may be any computer known to those skilled in the art including standard attachments and components thereof (for example, a disk drive, a hard drive, CD/DVD player and/or network server that communicates with a central processing unit and main memory, sound board, keyboard, mouse and/or printer). The server may include any number of task-oriented applications, such as web browser applications. Web server 36 utilizes the Internet as an exemplary communications backbone and allows information to be passed to the participant's browser. According to particular embodiments, Web server 36 may include a form handler to collect and process information submitted by a user through browser application 38.

While not illustrated, organization 14 may include a plurality of web pages for display on one or more web sites, brochure sites, competition sites, shopping sites, sites for uploading and/or downloading information, merchandise sites, champion merchandising sites, feedback sites, blogs, etc. For example, brochure sites may include descriptions of charities, artists, other users, videos, facts, competition formats, competition listings, organization descriptions, accounting rules, video assets available to users, video uploading formats, celebrity panel preferences, champion pages, and pages, etc. Competition-specific sites may reference, link to, and/or include social components, login pages, champion community pages, fan community pages, member pages for data entry and uploads, etc. Organization agents 22 and/or organization 14 may collect, store and/or share user feedback regarding competitions and various aspects of organization 14. The plurality of websites may include any number and/or type of e-commerce store modules, graphical art interface modules, and/or marketing modules. The plurality of websites may integrate search engine marketing and social networking techniques to drive sales and increase the conversion rate of a site.

The plurality of websites may include mobile websites to provide users and internal staff with an online experience that is equally usable on personal computers as well as mobile devices as users access data from many different platforms and on many different devices. The websites may be architected and optimized to perform on many different web browsers, including mobile browsers such as those found on an iPhone, iPad, BlackBerry, droid, and HTC devices. The websites may function using a plurality of instructions stored on a Web server and executed on a computer. The instructions may include any one or more computer code formats such as certified CSS/XHTML, DHTML, .NET development, PHP, mySQL, computer code that comply with W3C standards and/or any number and/or type of other code standards-based languages and utilities. Communication between Web server and web browser application may be achieved by any means using any methods including any computer languages generally now or in the future known in the art.

According to particular embodiments, organization agents 22 and/or organization 14 may manage content provided by the plurality of websites through any type of content management system of organization 14 or of service provider 12. Managing content may include editing photos, uploading videos, replacing headlines, modifying descriptions, modifying rules, managing views, managing rules, managing votes, managing other aspects of competitions, etc. In particular embodiments, content management system may be protected by any type of password protected entry and/or other security tools, including any number and/or type of security layers.

In operation, organization 14 communicates over communication network 16 with users of organization 14. System 10 contemplates any suitable number and/or type of users of organization 14, including champions 50, fans 60, charities 70 and sponsors 80 promoting art 40. Users of organization 14 may include organization 14 as one or more artists supplying art 40, champions 50, fans 60, charities 70 and sponsors 80 promoting art 40. Users of organization 14 represent any one or more of individuals, corporations, commissioners, concierges, agents, brokers, friends, fans, sponsors, artists, organizations, actors, animators, film directors, film editors, film producers, potential sponsors, charities, mobile application developers, talent buyers, talent scouts, talent agents, celebrities, internet video users, musicians, record labels, record label representatives, screenplay writers, teachers, professors, academic advisors, local political parties, political campaign candidates, national political parties, sports leagues, sports teams, athletes and/or any other online user. Users of organization 14 may represent an operator or application that accesses system 10 for interaction with organization 14. According to particular embodiments, users may promote, upload, create, enter into an art competition, access and/or manage particular ones of art 40. One or more users may access and/or manage a team for a particular competition. According to particular embodiments, one or more authorized users of ad agencies, brand management entities, publishers or other operators that deploy advertisements. Users may be one or more advertiser users that can access and/or manage a given advertising campaign or group of campaigns in system 10. According to particular embodiments, users may include publishers who manage one or more web sites and desire advertising of the organization 14 on one or more publisher web sites. According to particular embodiments, users may select and retrieve content using one or more content sources, potentially including advertising content, and render content for playback.

As illustrated in FIG. 1, organization agent 22 and/or organization 14 store in one or more databases accessible to organization 14 information relating to organization 14 and users of organization 14, such as user profiles 30, profile algorithms 32, descriptions 44, accounts 26, accounting rules 28 and business functions 34. According to particular embodiments, business functions 34 include promoting artist successes and making charitable contributions within the context of competitions. Business functions 34 may include a range of allocation of revenues based on percentages. For example, one business function 34 of organization 14 may include allocating one-third of revenues to various artists who win art competitions, one-third of revenues to charitable contributions and the remainder of revenues to the organization 14. Business functions 34 may be profit driven, corporation driven, dynamically created or otherwise specified to support appropriate interactions between organizations 14, champions 50, fans 60, charities 70 and sponsors 80. Organization 14 achieves results from system 10 by exposing opportunities for artists and charities, maximizing creativity using a competition format, and leveraging local, regional and online social networks. According to particular embodiments, business functions 34 include one or more scoring algorithms. For example, one algorithm may calculate a score for an exemplary work of art 40 based on a number of views on a web page of the art 40. As another example, another algorithm may calculate a score for an exemplary work of art 40 based on quality as interpreted by various users of the organization 14. In this example, the quality score may represent an average of art quality ratings submitted by users on a scale, for example, of 1.0 to 12.5, for a given round of a competition. As another example, another algorithm may calculate a score for an exemplary work of art 40 based on the amount of money contributed through entry fees to a competition and/or credits spent by users to vote for the art 40. As another example, another algorithm may calculate a score for an exemplary work of art 40 based on feedback from fans 60 received prior to the competition and/or that round of the competition. As another example, another algorithm may calculate a score for an exemplary work of art 40 based on fan resonance from registered fans 60. According to particular embodiments, champions 50 may provide a fan resonance version of art 40. For example, if a song contains difficult to replicate riffs or potions of the song, champions 50 may provide a fan resonance version of the song, which may include a simplified musical bridge for purposes of providing a default measurement of fan resonance for that portion of the song that is difficult to replicate. According to particular embodiments, ranking criteria 308 may include an art quality ranking based at least in part on an amount of difficult to replicate musical content within a particular song. In this circumstance, the fan resonance measure would be negatively impacted if the musically oriented fans were unable to replicate the music. Champions will be able to provide a separate fan resonance version of their song in order to enable fans to more easily replicate the song.

According to particular embodiments, descriptions 44 represents textual descriptions of organization 14 and may include textual descriptions of organization selected charities. Descriptions 44 may also include textual descriptions of a plurality of competitions in the past, present and future, and may include any number of audio and/or video components that describe the competitions, including pictorial images.

According to particular embodiments, descriptions 44 represent one or more formats for competitions. For example, a competition format may be a bracket competition, a free form competition, and/or any suitable competition having multiple rounds. Competitions may include decision trees in conjunction with or instead of bracket competitions. In this example, users vote by selecting which scene, for example, they would like to view, whether or not the scenes are arranged in one or more orders or formats. Descriptions 44 may also include a plurality of double double tipping points, wherein each double double tipping point corresponds to a particular competition. Each double double tipping point includes an announcement date and a start date. For example, organization 14 may announce a competition on an announcement date and include in the announcements a specified number of champions and a specified number of fans that must register for the competition before the competition may begin. Once the specified number of champions and the specified number of fans are reached, the competition satisfies the double double tipping point and may begin. If a double double tipping point is not satisfied prior to the start date, the competition will begin on the start date. According to particular embodiments, organization 14 determines positioning of champions 50 for a bracket competition using any number, type and/or combination of various criteria. For example, a competition having a relatively higher number of champions 50 may have a higher number of rounds of a competition and thus a higher number of positions. As another example, positioning of champions 50 may be determined using geographical location. As another example, positioning of champions 50 may be determined using various results of art ranking engine 16 and/or ranking criteria 308. As another example, positioning of champions 50 may be based on fans 60, charities 70, sponsors 80 and/or artists 90. For example, if a competition has sixteen champions 50, a bracket format for the competition may resemble a sweet sixteen bracket as used by the National Collegiate Athletic Association (NCAA) for college basketball tournaments. According to particular embodiments, a bracket competition includes multiple rounds of competition, which may represent only a portion of total rounds of a competition. In some embodiments, positioning of champions 50 for an art competition bracket may be based on competitions or rounds of competition prior to or after the bracket competition. In other embodiments, positioning of champions 50 may be determined by one or more users such as a sponsor 80 or champion 50 or non-users such as an advertiser or application service provider. For example, positioning criteria may include start and end dates, potential users targeted by particular users or non-users, positioning costs to organization 14 such as cost per click, cost per impression, cost per action and/or cost per lead, and/or positioning payments to organization 14 such as pay per click, pay per impression, pay per action and/or pay per lead.

In operation, accounts 26 may represent dollars or other actual currency, virtual currency such as credits or tokens, a specific relationship of virtual to actual currency or currency share, and/or any combination of actual and virtual currency. According to particular embodiments, in operation, actual or virtual currency is transferrable from one account 26 to other one or more accounts 26 using any means or methods. According to particular embodiments, in operation, credits may be transferred from one account 26 to other one or more accounts 26 when a transfer process is initiated, for example, by online activity, text messaging, or other input that may spend credits in whole or in part. Such input may be represented by input into a wireless apparatus, interface, personal digital assistant, stand-still terminal at a particular location or other terminal configured to accept transfer commands, voting commands, or pay-per-art selection transaction. According to particular embodiments, credits may be used during a live event.

According to particular embodiments, accounts 26 include credits for online activity contributed by fans 60 and/or sponsors 80 in support of art 40. Accounts 26 may be allocated at any given time, including prior to a competition, portions for allocation to artist successes and charitable contributions to a cause for which an artist is passionate. Accounts 26 may also include sponsor accounts. For example, a sponsor account may include a matching percentage of user entry fees that a sponsor agrees to contribute for a particular competition and a match limit that defines the maximum amount contributed by a sponsor for a competition. According to particular embodiments, art ranking engine 16 accesses multiple ranking criteria 308, such as, for example, scoring or scorekeeping criteria, to determine a winner such as a winning user account or a winning user. In some embodiments, accounting rules 28 may define a user's credits for online activity to be competition-specific such that the credits for online activity for a particular competition expire at least in part after the competition is over and some, all or none of the competition-specific credits are allocated to one or more of an organization 14, organization agent 22, winning artist, winning fan, winning charity and/or winning sponsor. In other embodiments, accounting rules 28 may define a user's credits for online activity to be transferrable in whole or in part to the user's account for another competition or to an other user's account for the same or different competition.

According to particular embodiments, in operation, accounts 26 may be distributed by the organization using, for example, a payment processor widget as follows: charity distribution of 35%, artist distribution of 35%, champion distribution of 15% and organization distribution of 15%. The portion of an account 26 allocated to charities may be divided into one portion for the benefit of a champion selected charity and another portion for the benefit of an organization selected charity. An organization may designate an organization selected charity for a particular competition. For example, the portion of account 26 allocated to charities may be divided into 29.5% for the benefit of a champion selected charity and 5.5% for the benefit of an organization selected charity for a total of 35%. In this example, 85% of the charity portion benefits a champion selected charity and 15% of the charity portion benefits an organization selected charity. An organization may select and organization selected charity using organization agent 22. Upon registration, charities 70 provide various accounting details such as, for example, charity name, tax ID number, website address, logo file, contact first and last name and email address, weekly goal and yearly goal for charitable contributions. According to particular embodiments, charities 70 sell tickets to online single or multiple entries, competitions, and/or online activity.

According to particular embodiments, accounts 26 provide a profitable opportunity for artists such as video and music recording artists and a contribution opportunity for artists to raise money for cause about which they are passionate. According to particular embodiments, in operation, accounts 26 may generate tips for artists and charities from their fans and sponsors. According to particular embodiments, champions 50 recruit fans 60 and/or sponsors 80 using their contacts and social networking channels, such as, for example, Facebook or Twitter. In operation, fans 60 and champions 50 may communicate with their contacts through websites of organization 14 or websites linked to websites of organization 14. accounts 26 may be represented graphically using a payment processor widget associated with a particular user and apart from any given competition. Champions 50 may provide a link to their accounts 26 in an e-mail, text message or other electronic communication over a communication network 16 to one or more contacts. In this way, accounts 26 of fans and sponsors may be linked to artists and charities through champions 50.

A payment processor widget represents any suitable applet, widget, flash utility, java utility, and/or any compilation of code that may be executed by a personal computer or a mobile device in order to process a virtual payment to and/or from a virtual account. The payment processor widget communicates with organization 14 to transfer data collected by the payment processor widget to accounts 26 for purposes of maintaining accounts 26 in accordance with accounting algorithms. According to particular embodiments, accounts 26 may convert dollars using accounting rules 26 of organization 14 to tokens and/or any combination of tokens and dollars. For example, at the Texas State Fair, attendees may purchase tickets using actual money and exchange tickets for rides, food and merchandise.

According to particular embodiments, the techniques described herein for strategic management of entry fees to a particular competition and/or to register for a user account with organization 14 enable an organization to generate artist successes and charitable contributions. For example, organization 14 may allocate a specific portion of entry fees of one user to another one or more users' accounts. Users may then use their accounts to acknowledge particular artists and particular charities. Such acknowledgements may occur when a user uses online activity to support an artist's entry to a competition. According to particular embodiments, when an amount of money is paid for a virtual account of a new user, a corresponding amount of money is added to the virtual account of a referring user where the referring user is linked to the new user during the registration process using a discount code associated with the referring user. According to particular embodiments, a referring user pays an amount of money to organization 14 upon registration or at a later time for discount code credits, and the referring user may receive a whole or partial reimbursement for a single one of the discount code credits upon payment by a new user of an entry fee to organization 14.

According to particular embodiments, accounting rules 28 may include recording, by a server for the online environment, a user profile comprising a user identifier of a user account. According to particular embodiments, profile algorithms 32 may include an algorithm to generate a link for associating a user identifier of a user account for use by the user for recruiting one or more additional users by sending additional users the link.

According to particular embodiments, exemplary ranking criteria represent a count of views of art 40 for purposes of ranking art 40. In operation, organization 14 maintains a count of views of art 40 for purposes of ranking art 40. In particular embodiments, this process may represent fan resonance or resonance. Resonance is the retention and expansion of an audience. For example, when a Web site resonates, it grows a large audience quickly. Resonance results from normal human behavior. People tend to do two things when they find a Web site they like: they tend to come back to the web site, and they tend to tell their friends about the web site.

Organization 14 enables users to access art 40. Art 40 may include original content submitted to organization 14 by champions 50 over communication network 16 using interface 42. Art 40 may also include organizational content originated and/or provided by organization 14. Organization 14 collects and stores art 40 and browser application 38 accesses this information over communications network 16 using Web server 36. Organization 14 may access some or all art 40 for use in art ranking engine 16 to rank any ones of art 40. Art services 18 may access some or all art 40 for supplying, uploading and/or viewing art 40 for purposes of providing art services 18 to users of organization 14. Organization 14 may collect and store results of art ranking engine 16 and/or services 18 and use those results to create one or more profiles 30 according to profile algorithms 32. Organization 14 may debit and/or credit accounts 26 based on results of art ranking engine 16 according to accounting rules 28. Organization 14 may supply descriptions 44 to users through browser application 38. According to particular embodiments, organization agent 22 represents a division of organization 14 and offers entertainment marketing services. For example, each Champion 50 that registers may receive multiple business cards to give to potential users to promote their entry of art 40 in an art competition. Artist 90 may be his or her own agent and/or fan and may have single and/or multiple user accounts. Artist 90 and organization 14 may jointly create art. Artist 90 and fan 60 may jointly create art. Artist 90 and champion 50 may jointly create art.

Interface 42 provides a link between organization agent 22 and other entities within system 10. Depending upon the particular types of communications and configurations within system 10, interface 42 may include any suitable combination of hardware and/or logic for interacting with other components of system 10. For example, consider service 18 providing a video uploading service. In response to a query from organization agent 22, service 18 may supply details of features such as video clips, images, crowd decibel levels for particular scenes and other appropriate features. Thus for example, organization agent 22 may access service 18 to determine appropriate features interfaces 56 and then interact with service 18 to request details of features. If details of features meet certain criteria, organization agent 22 may order the video and provide information for service 18 to supply details of features. For example, organization agent 22 may supply various algorithms and instructions to collect details of features, such as viewing criteria, uploading criteria, and social media networking connections of users.

Champion 50 represents a person or a team who selects a cause to champion, manages and enhances the art product created originated and/or submitted and promotes the art and a cause to the fan base. According to particular embodiments, champions 50 may earn money for their cause and for themselves throughout each competition. Champions can be talent agents, literary editors, band managers, film editors, disco jockeys, video jockeys, film producers, video producers, directors, record labels, video editors, broadcasters, promoters, band managers, political debate hosts such as local political parties, etc. According to particular embodiments, champions 50 may create and/or contribute art for competitions and/or edit and/or promote art contributed by champions 50. For example, a first Champion 50 may create and contribute organizational content for a competition, and a second Champion 50 may edit and promote the organizational content contributed by the first Champion 50. According to particular embodiments, champions 50 may create, edit, frame, finish, and/or package art 40 and/or derivative works of art 40. Champions 50 may promote one or more artists 90 and/or works of art 40 and may gain support from fans 60, sponsors 80, charities 70, etc. Champions 50 promote art 40 from start to finish of a competition from one round to the next round to a final round. A winning artist for a given round of a competition represents an art 40 that is promoted to a next round of a competition based on results of art ranking engine 16.

Champions 50 may organize a team of artists to promote one or more works of art 40 of the team. Each team may represent a particular city or otherwise pre-approved geographical area. Each team may be selected by an area champion 50. Each team champion 50 may choose team members and a management team that may include team members serving multiple roles for the team. For example, there may be twenty team members, and each team member may serve a primary role such as, for example, four musicians, three film crew members, three video game development team members, one classical artist such as a painter or sculptor, one corporate sponsor representative, one activist genius, one comedy troupe having three members, one member representing a charity, one web social networking genius, and one fashion designer.

Champions 50 may recruit fans 60 and other users of organization 14. According to particular embodiments, champions 50 may receive referral fees from accounts 26 when fans 60 and/or champions 50 register for an account 26 for a competition. Champions 50 may also receive referral fees when sponsors 80 register for a competition. For example, when a sponsor 80 registers for a competition, sponsor 80 commits a sponsor match percentage up to a particular match limit of money, and pays sponsorship amounts to organization 14 for sponsored entries based on the sponsor match percentage up to the match limit.

According to particular embodiments, for example, champion 50 that recruited sponsor 80 may receive a percentage of sponsorship in an amount between 28% and 42%, such as 35%, of amounts paid by sponsor 80. According to particular embodiments, champions 50 may receive referral fees by recruiting other champions 50. In this way, champions 50 who recruit their own competitors and sponsors may receive not only referral fees from champions 50 and fans 60, through payment processor widget, for recruiting other champions 50 and fans 60, but also a percentage of sponsorship paid by sponsors 80 recruited by champions 50. For example, champions 50 may receive 35% of sponsorship from sponsor accounts 26 as a referral fee, in credits for online game play, or in any number of or a combination of actual, withdrawable money or credits for online activity. Referral fees, credits for online game play, discounts for recruiting, and amounts of of actual, withdrawable money may be competition-specific. During registration of a sponsor 80, sponsor 80 may enter information such as sponsor, company name, contact name, contact email address, website address, logo and description. During registration by a sponsor 80, sponsor 80 may optionally designate a percentage match commitment to match various amounts contributed to a particular entry, and a maximum sponsorship amount. In particular embodiments, where a sponsor 80 is recruited by a champion 50 and/or a fan 60, the sponsor 80 may provide information that identifies the recruiting user and, optionally, a description of the relationship between the sponsor 80 and the recruiting user. According to particular embodiments, sponsors 80 may upload advertisements for advertising purpose on organization 14 websites.

According to particular embodiments, champions 50 may accumulate, assimilate, edit and/or derive measurements from art 40 and/or input based on art 40 from fans 60, artists 90 and/or other users or non-users of organization 14. For example, champions 50 may receive input from musicians such as musically skilled fans 60 based on how well fans 60 replicate musical art. For example, replications may be vocal. As another example, replications may be based upon a particular instrument. As a further example, replications may be based upon an ensemble. According to particular embodiments, input may represent results from art ranking engine 16. According to particular embodiments, one or more components of system 10 may determine a song from fan 60 that is the most similar to a song from champion 50 using results from art ranking engine 16 and select the most similar song as a winning song. According to particular embodiments, users are made aware of particular ranking criteria 308. For example, organization 14, potentially through art ranking engine 16, may provide musically skilled fans 60 with an analysis of particular ones of art 40 input into art ranking engine, possibly by particular fans 60, and/or provide a ranking or other comparative or numbered output from particular ones of art 40. Art ranking engine 16 may use any number and/or type and/or combination of ranking criteria to rank art 40. According to particular embodiments, users may interact with art ranking engine 16 by providing inputs to and receiving outputs from art ranking engine 16 on computers, laptops, mobile or other devices or networked apparatus through any graphical user interface such as that provided by an applet running on a web browser application 38.

Fans 60 represent users of organization 14 that participate in online activity to acknowledge art for art's sake by, for example, viewing art, commenting in one or more online forums, blogging about art, sharing art and/or voting for art. According to particular embodiments, in operation, fans 60 view art 40 online that is entered into an art competition, and organization 14 may keep track of the number of views of art 40 for purposes of ranking art 40. Upon registration, fans 60 may enter a discount code received by a referring user, choose a favorite champion 50, choose a cause (and a champion 50 associated with that cause), and pay the entry fee to a competition. A total amount owed for registration may include, for example, an amount for an entry fee, an amount for credits for online activity, an amount for discounts for recruiting users that are transferred upon redemption by a recruited user and, possibly, an amount for a referral fee to organization 14. In a competition, when fans 60 vote on art 40 using accounts 26, organization 14 keeps track of the number and/or amount of votes for the art 40 for purposes of ranking the art 40. According to particular embodiments, organization 14 may utilize art quality scores to rank art 40. Fans 60 may submit an art quality score, for example, using a sliding scale for art quality on a scale from 0 to 12.5, with 12.5 being the highest possible score for art quality. Fans 60 interact in social media networks and online environments implemented by computer networks. Fans 60 may interact in other interactive media such as interactive television, local media and other local networks for social and business networking purposes locally, regionally, nationally and internationally.

Sponsors 80 advertise products and brands to various individual and organizational users and promoters of social media networks, virtual environments implemented by computer networks and other interactive media such as interactive television, local media and other local networks. According to particular embodiments, sponsors 80 may represent broadcast networks, mobile networks, internet networks, and/or other platform. Such advertisements are typically distributed to social media network users using user location information, user web history and user preferences such as product purchase information. Users of social media networks may also advertise likes and/or dislikes, opinions, products and brands to the public and/or to all or selected groups or selected ones of their friends and/or fans within the social media network for purposes of gaining attention and support from their social media network connections and gaining new social media network connections. Users of social media networks may be incentivized to advertise to their friends in return for rewards such as coupons, status advantages within the social media network, real money and/or virtual money. Sponsors 80 may represent advertisers desiring to collect data regarding consumer preferences.

According to particular embodiments, sponsors 80 represent businesses that sponsor competitions, champions 50, and art 40 by matching accounts 26 at a certain percentage match up to a limited amount. According to particular embodiments, where a champion 50 recruits a sponsor 80, a sponsor account 26 of the sponsor 80 may include an identifier of the champion accounts 26 of the champion 50. Alternatively or in addition, where a champion 50 recruits a sponsor 80, a sponsor profile 34 may include an identifier of the champion 50 or champion profile 34 of the champion 50. Such identifiers may be accessed by one or more databases, such as in a table, to determine relatedness of users and/or user accounts. In this way, accounts 26 of sponsors 80, i.e. sponsorships, may directly benefit champions 50 through a referral fee, such as, for example, 15% of sponsor account 26. Organization 14 may generate profiles 34 of sponsors 80 according to profile algorithms 32. Sponsors 80 may receive recognition on a profile web page that displays a profile 34. Sponsors 80 may receive brand recognition on web pages promoting particular competitions. Sponsors 80 received more brand recognition when the champions 50 that recruit them advance to a next round of the competition. Sponsors 80 may offer discounts, promotions and other benefits to fans 60 using any number of discounts using promotional codes. According to particular embodiments, organization 14 may measure charitable impact of sponsors 80 by counting each instance in which discounts are used. In this way, organization 14 provides sponsors with value through brand recognition and goodwill creation.

According to particular embodiments, sponsors 80 may represent broadcasters which may have pre-existing business relationships with sponsors and/or advertisers. In operation, organization 14 may accept any number and/or type of payments from one or more sponsors 80. For example, an exemplary payment may include a portion for one or more advertising packages. In this example, advertising packages may include adwords, run of site advertising, radio and television media buys, sponsor mentions and/or other product placement or service placement for advertising any one or more components of system 10, such as various aspects of organization 14, organization agents 22, art services 18, or users of organization 14, such as a particular champion 50, fan 60, charity 70, sponsor 80 or artist 90. In this example, credits for online activity may be credited from a sponsor account 26 to a different user account 26 of a user that may be associated with a particular sponsor 80.

According to particular embodiments, sponsorship opportunities may include categories of sponsorship. For example, sponsorship categories may include categories based on geographical area, industry, art format, charity and/or type of charity and/or cause supported. Categories may be promoted by creating giveaways, sweepstakes and contests in an online environment such as a social media or gaming environment. For example, platforms such as www.wildfireapps.com may be used to promote particular art, artists, champions, charities, fans, sponsors and/or products and/or services of users. According to particular embodiments, a payment for a sponsor account or other user's account may include a portion for use of such platform. For example, such platforms may enable users to build social media marketing campaigns, reach potential users across multiple platforms, generate leads, build brand awareness, perform real-time analytics, download analytics in real-time, analyze user behavior, aggregate profiles, and collect demographic information and other information about users such as social networking connections of users, whether a user is a brand ambassadors, friends of users, etc. According to particular embodiments, a payment for a user account from a user, another user, a non-user, a user account, another user's account, a non-user account, or an account outside of organization 14, within or outside of system 10, may include a portion in exchange for social media marketing tools, such as tools for building an application. According to particular embodiments, a payment processing step for a sponsor's account or other user's account may include crediting the account in exchange for receiving a payment for another user's account recruited using the social media marketing tool payment portion of the sponsor's account or other user's account.

According to particular embodiments, giveaways and prizes provided by sponsors 80 may be awarded to winning champions 50 determined by art ranking engine 16 using one or more ranking criteria 308 to rank various champions 50 such as champions 50 in a competition and/or champions 50 in a particular category. According to particular embodiments, sweepstakes may be used to recruit additional fans 60 and/or sponsors 80 on behalf of particular charities 60 and champions 50. According to particular embodiments, broadcasters may recruit sponsors 80 in some, none or all particular categories. For example, a country and western radio station in Dallas may be a sponsor 80 such as a founding sponsor 80 for a Dallas Country and Western bracket competition for travel to and registration for a Texas Country and Western competition having various formats and awards such as actual money, virtual money, and/or travel to and registration for additional competitions. According to particular embodiments, sponsors 80 may represent providers of additional services to competitions and/or winning users, such as a host of a live event or a host of a final round of a competition. For example, sponsors 80 may include film festivals, music festivals, and live venues.

According to particular embodiments, at least some users participate in art competitions via computer input by a computer, which may include desktop or laptop computers having a modem to connect with the network 16 for communication purposes using a web server. System 10 may optionally include stand-alone units capable of printing credits in the form of tickets, coupons, magnetically readable cards, cards with barcodes, or any other type of smart card which may be redeemable at the site of a competition. Input within a competition may include voting and/or other user participation in any suitable number and/or type of competition format or other environment to promote artists. According to particular embodiments, competitions may include online art creation in various mediums of art 40. According to particular embodiments, virtual art competitions mirror local art competitions online for worldwide viewing.

Organization 14 may include both functional aspects, such as art ranking engine 16 and feature interfaces 42, and data aspects, such as descriptions 44. However, while illustrated as including specific elements arranged in a particular configuration, system 10 contemplates services 18 including any suitable combination arrangement and elements for providing network accessible services. System 10 contemplates services 18 including any suitable combination of hardware and/or logic and the functionalities of services 18 being incorporated in and/or provided by any suitable network accessible equipment.

The illustration provided and the preceeding description present generic elements for implementing a system to enable automated, agent-based interaction between an organization and any number of champions 50, fans 60, charities 70 and sponsors 80. However, while the embodiment illustrated includes specific components arranged in specific ways, it should be understood that this illustration, accompanying description, and all examples given are provided only to aid in clarifying the basic concepts of these techniques and none of these are intended to limit the scope of these concepts.

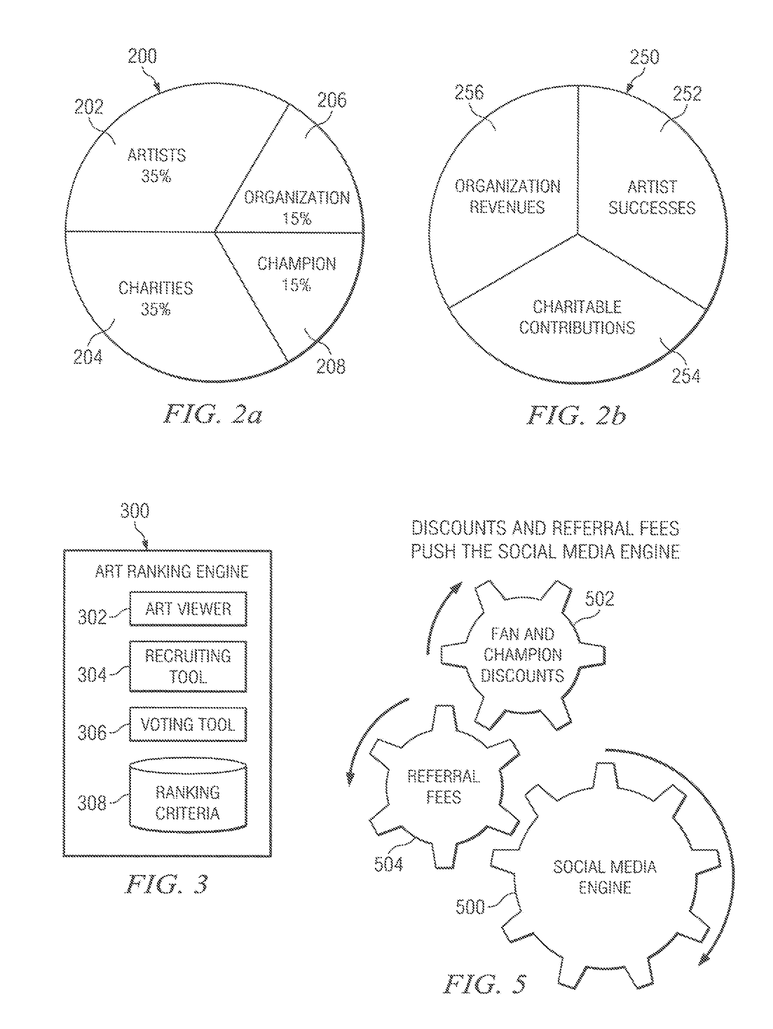

FIG. 2a is a pie chart 200 illustrating business function 200. According to particular embodiments, business function 200 may include distributing revenues of the organization to promote artists and charities within the context of competitions. As illustrated, the sum of organization portion 206 and champion portion 208 may be approximately the same or similar to artists portion 202 and charities portion 204. According to particular embodiments, business functions 34 may include a range of allocation of revenues based on percentages for any given one or more or all competitions of organization 14. In exemplary embodiments, business functions 34 of organization 14 may include allocating one-third of entry fees to a particular competition to the artist 90 who wins the competition(i.e. the “winning artist”). In exemplary embodiments, business functions 34 of organization 14 may include allocating one-third of entry fees to a particular competition to charitable contributions to one charity selected by the organization and to a second charity selected by the artist who wins the competition. In exemplary embodiments, business functions 34 of organization 14 may include allocating one-sixth of all entry fees to the particular competition to the champion who wins the competition (i.e. the “winning champion”). In these exemplary embodiments, organization 14 may receive the remainder of all entry fees in revenues. According to particular embodiments, one or more organization agents 22 may collect and/or receive at least a portion of, some, all or none of the portion allocated to artists 90. Business functions 34 may be profit driven, corporation driven, dynamically created or otherwise specified to support organizations 14, champions 50, fans 60, charities 70 and sponsors 80. Business functions 34 function to define the results that an organization 14 may achieve for artists and charities from an online environment as illustrated, for example, by system 10. According to particular embodiments, business functions 34 may define a competition format for maximizing the creativity of various artists for creating art 40. According to particular embodiments, business functions 34 may include leveraging one or more local, regional and/or online social networking connections.

The illustration provided and the preceding description present generic elements for implementing an illustration of an exemplary allocation of revenues of an organization. However, while the embodiment illustrated includes specific components arranged in specific ways, it should be understood that this illustration, accompanying description, and all examples given are provided only to aid in clarifying the basic concepts of these techniques and none of these are intended to limit the scope of these concepts.

FIG. 2b is a pie chart illustrating distribution of combined entry fee 250. In general, the sum of the components of the combined entry fee 250 provides enough support to an organization to sustain its existence and/or prosperity while maintaining its goals to generate artist successes and charitable contributions. The combined entry fee 250 includes a virtual account deposit, a referral fee and/or a discount and a maintenance fee. As illustrated, distribution of a combined entry fee 250 is egalitarian as between the organization revenues, artist successes, and charitable contributions. While not illustrated, the combined entry fee 250 may also include any other suitable components to provide enough support to an organization to sustain its prosperity while fulfilling its purpose to generate artist successes and charitable contributions.

Processing a combined entry fee 250 may include allocating the entry fee into a plurality of organizational revenues 256, a plurality of artist successes 252, and a plurality of charitable contributions 254 according to allocation instructions such that the organization sustains its prosperity while fulfilling its purpose. Allocation instructions may depend upon organizational objectives. Examples of organizational objectives include artist successes and charitable contributions. In this way, organization 14 may promote artists by paying artists at least a portion of accounts receivable in an online environment.

The illustration provided and the preceding description present generic elements for implementing an illustration of an exemplary allocation of revenues of an organization. However, while the embodiment illustrated includes specific components arranged in specific ways, it should be understood that this illustration, accompanying description, and all examples given are provided only to aid in clarifying the basic concepts of these techniques and none of these are intended to limit the scope of these concepts.

FIG. 3 will be described below both generically and specifically with respect to particular types of elements and operations. FIG. 3 illustrates art ranking engine 300. Art ranking engine 300 includes art viewer 302, recruiting tool 304, voting tool 306 and ranking criteria 308. According to particular embodiments, art ranking engine 300 determines a winning user according to one or more ranking criteria. In particular embodiments, art ranking engine 300 may utilize ranking criteria 308 in conjunction with traditional research and measurements including quantitative and qualitative market research, online media tracking, website analytics, sales data, public relations data, advertising data; investor relations information, brand management analysis, brand impact analysis, product research information, and product development information. According to particular embodiments, ranking criteria may include or may be used for ranking in conjunction with other measurements such as measurements of light from laser beam pointers, projection from fan specific projection devices, counting of any number and/or type of users and/or user clicks online on one or more web pages, decibel levels of crowds cheering, and/or decisions based on decibel decision making.

The illustration provided and the preceding description present generic elements for implementing an art ranking engine of the organization. However, while the embodiment illustrated includes specific components arranged in specific ways, it should be understood that this illustration, accompanying description, and all examples given are provided only to aid in clarifying the basic concepts of these techniques and none of these are intended to limit the scope of these concepts.

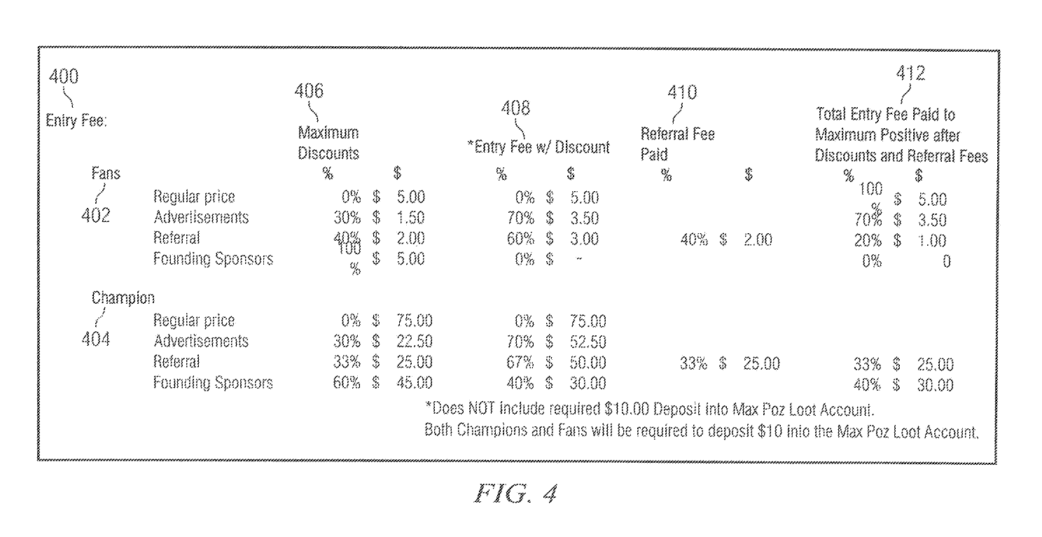

FIG. 4 illustrates an exemplary table of entry fees to an art competition. FIG. 4 illustrates an exemplary entry fee 400. Entry fees for fans 402 and champions 404 are provided. Column 406 illustrates maximum discounts based on percentages that may be redeemed by various fans 402 and champions 404. As illustrated, fans 402 or champions 404 pay to organization 14 a discounted entry fee as shown in column 408. Column 410 illustrates an amount paid to a referring user in an amount of a referral fee upon registration by referred fans 402 or champions 404. As illustrated, a total entry fee paid to organization 14 after discounts as shown in column 406 and referral fees as shown in column 410 is illustrated in column 412. The amounts shown in table of entry fees of FIG. 4 do not include portions of registration fees that are deposited for purposes of credits for online activity.

According to particular embodiments, upon registration, a fan for a champion may pay a minimum deposit of $10 to organization 14 for purposes of credits for online activity. For example, a minimum deposit of $10 paid for a four week competition may be divided into $2.50 per week. In this example, fees for voting may be deducted from the account at a rate of $0.25 per vote. Accordingly, a fan 60 or champion 50 may use credits for online activity ten times per week at $0.25 per use totaling $2.50 per week for online activity. According to particular embodiments, if a fan does not vote in any given voting week for a competition, the $2.50 may be spent by organization 14 automatically to vote for a fan's favorite entry or a champion's favorite entry to the competition. A default favorite entry may be the last entry voted for by the fan or champion. If such entry is voted out of the competition, organization 14 may allocate competition-specific credits for online activity to one or more user accounts associated with the entry that won over the favorite entry. Both champions 404 and fans 402 deposit to organization 14 amounts for purposes of credits for online activity in addition to entry fees for a competition. According to particular embodiments, entry fees may be competition-specific or may be included in a registration fee. According to particular embodiments, organization 14 may charge extra for additional purchases and/or downloads that may or may not be competition-specific. For example, organization 14 may charge shipping and handling fees for various other products and services. The illustration provided in the preceding description present generic components of fees paid to organization 14. However, while the embodiment illustrated includes specific amounts in various colons, it should be understood that this illustration, accompanying description, and all examples given are provided only to paid in clarifying basic concepts and none of these are intended to limit the scope of these concepts.

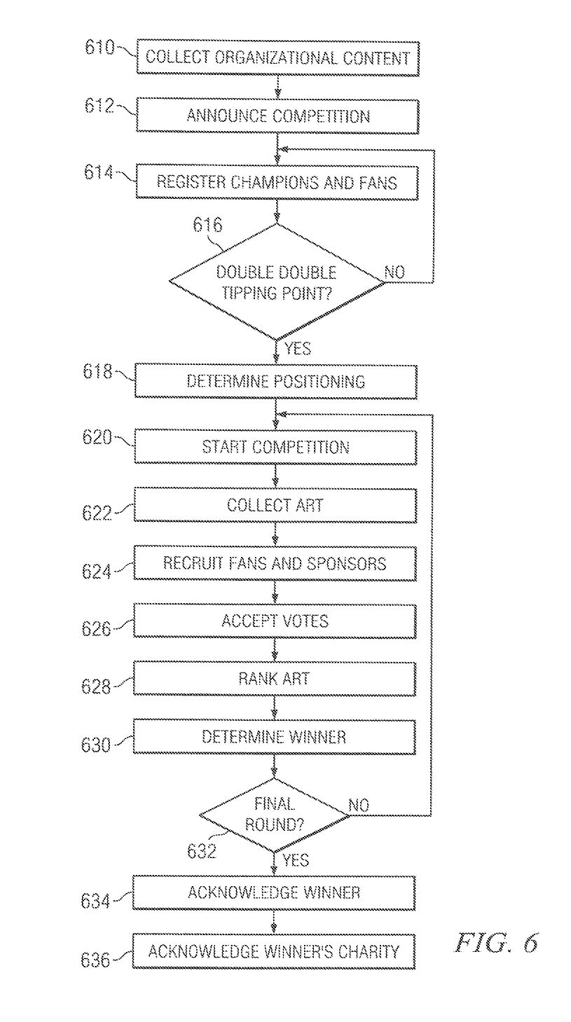

FIG. 5 illustrates a functional diagram showing the relationship between the function of sharing social networking connections of users by accessing one or more social media engines to the purpose of generating artist successes and charitable contributions in an online environment. As illustrated, according to particular embodiments, organization 14 utilizes referral fees 504 and fan and champion discounts 502 to leverage various social networking connections of users that the organization 14 may access using social media engine 500. The various operations shown in the functional diagram of FIG. 5 include pushing to social media engine 500 using referral fees 504 and fan and champion discounts 502.

According to particular embodiments, fan and champion discounts 502 may be redeemed by debiting a virtual credit account of a first user in an amount equal to a discount amount off of the purchase price of an entry fee paid using a second user account. In operation, an organization 14 may receive results of a processor upon processing a discount 502 associated with a first user redeemed during registration of a second user. For example, the second user may communicate the discount 502 of a first user using a graphical user interface accessed by the second user's computer over a communication network during account registration.

According to particular embodiments, referral fees 504 represent amounts paid into a first user's account when a second user recruited by the first user or a recipient of the benefits of a first user's account registers for an account. For example, an exemplary referral fee 504 may be paid to a first user when, after one or more rounds of a competition, a number of unused second-user discounts 502 are automatically deducted from the second user account and that number of first-user discounts 502 are automatically added to the first user account. According to particular embodiments, a referral fee 504 may be paid to a first user or a third user receiving the benefits of referral from a first user's account. As another example, an exemplary referral fee may be paid to a first user when, after one or more rounds of a competition, a number of unused second user virtual credits are automatically deducted from the second user account and that number of first user virtual credits is automatically added to the first user account. According to particular embodiments, a referral fee 504 may be paid to a first user or a third user receiving the benefits of referral from a first user's account.

The illustration provided and the preceding description present generic elements for implementing an illustration of an exemplary function of the organization to leverage social networking connections. However, while the embodiment illustrated includes specific components arranged in specific ways, it should be understood that this illustration, accompanying description, and all examples given are provided only to aid in clarifying the basic concepts of these techniques and none of these are intended to limit the scope of these concepts.

FIG. 6 illustrates a functional diagram showing the various aspects of a method for generating artist successes and charitable contributions in an online environment. The various operations shown in the functional diagram of FIG. 6 include to collect organizational content 610, announce competition 612, register champions and fans 614, determine whether a double double tipping point has been achieved 616, and, if so, determine positioning 618 of champions 50 for a bracket competition, start competition 620, collect art 622, recruit fans and sponsors 624, accept votes 626, rank art 628, determine winner 630, determine whether a final round of the competition has been completed 632, and, if so, acknowledge winner 634, and acknowledge winner's charity 636. It should be noted that the foregoing functional aspects may be carried out in any order or not at all.

According to particular embodiments, organization 14 may decide certain positioning of various champions 50 for a bracket competition prior to a double double tipping point being met or after a double double tipping point has been met, as a competition may proceed even if a double double tipping point is never met. As another example, organization 14 may not perform the step of collecting organizational content 610 for competitions that do not include organizational content. In particular embodiments, champions 50 may submit art in combination with organizational content. In other embodiments, champions 50 may submit art by an artist 90 to a competition.

As illustrated in FIG. 6, organization 14 registers champions 50 and fans 60. A number of steps may be carried out to register any champion 50 and/or fan 60 for a competition. Registration may be executed at any time prior or during a competition or not at all in some embodiments. For example, champions 50 for a particular competition may include organization 14 and/or organization agent 22. In this example, organization 14 and/or organization agent 22 allocate credits to from one user account 26 to another user account 26 and/or to organization 14. Organization 14 pays portions of accounts for artist successes and charitable contributions. According to particular embodiments, a registration process of organization 14 includes registering champions 50 and fans 60. During registration, organization 14 may require input of personal information, such as a name and an e-mail address, on a web page using a graphical user interface. At this time, optional information such as demographic information about artists 90 associated with the champion 50 or supported by fan 60. Champion 50 may identify a champion selected charity to support at this time. Upon entry of at least necessary information, confirmation may be displayed to and/or sent to the registered user. Organization 14 may allow users to update user profiles.

The illustration provided and the preceding description present generic elements for implementing an illustration of an exemplary method of the organization. However, while the embodiment illustrated includes specific components arranged in specific ways, it should be understood that this illustration, accompanying description, and all examples given are provided only to aid in clarifying the basic concepts of these techniques and none of these are intended to limit the scope of these concepts.

Since the present disclosure describes particular embodiments and suggests numerous alterations to one skilled in the art, the present disclosure encompasses all embodiments and alterations within the scope of the appended claims.

What is claimed is:

1. A method for receiving and apportioning fees in an online environment comprising a plurality of user accounts, the method comprising:
receiving, by a server, a first payment to register for a first user account comprising:
a first portion in exchange for hosting the first user account;
a second portion in exchange for one or more first user credits for online activity; and
a third portion in exchange for one or more first user discounts for recruiting one or more second user accounts;
receiving, by the server, a second payment to register for a second user account; and
automatically crediting at least one other user account in an amount corresponding to at least a portion of redeemed ones of the one or more first user discounts.

2. The method of claim 1, further comprising:
automatically crediting at least one other user account in an amount corresponding to at least a portion of unused ones of the one or more first user credits.

3. The method of claim 1:
wherein the second payment comprises:
a first portion in exchange for hosting the second user account;
a second portion in exchange for one or more second user credits for online activity;
a third portion in exchange for one or more second user discounts for recruiting one or more third user accounts; and
a fourth portion for payment of at least one referral fee; and
further comprising automatically crediting at least one other user account in an amount corresponding to at least a portion of the referral fee.

4. The method of claim 1, wherein at least one first user credit is competition-specific.

5. The method of claim 1, wherein at least one first user discount is competition-specific.

6. The method of claim 1, wherein the step of automatically crediting at least one other user account in an amount corresponding to at least a portion of redeemed ones of the one or more first user discounts comprises automatically crediting the first user account.

7. The method of claim 1, further comprising:
determining a champion portion, an artist portion and a charity portion of a plurality of competition entry fees;
paying, after one or more rounds of a competition, the champion portion to a winning champion;
paying, after one or more rounds of a competition, the artist portion to a winning artist;
paying, after one or more rounds of a competition, the charity portion to one or more charities, wherein at least one of the one or more charities is selected by the winning champion.

8. The method of claim 1, further comprising:
ranking the user accounts based on online activity during a competition; and
selecting a winning user account based on the highest ranking one of the user accounts.

9. A system for receiving and apportioning fees in an online environment comprising a plurality of user accounts, the system comprising:
a server computer system that stores in one or more databases a plurality of user profiles and a plurality of user accounts;
a payment processor coupled to the one or more databases using a communication network, the payment processor operable to:
receive, by the server, a first payment to register for a first user account comprising:
a first portion in exchange for hosting the first user account;
a second portion in exchange for one or more first user credits for online activity; and
a third portion in exchange for one or more first user discounts for recruiting one or more second user accounts;
receive, by the server, a second payment to register for a second user account; and
automatically credit at least one other user account in an amount corresponding to at least a portion of redeemed ones of the one or more first user discounts.

10. The system of claim 9, wherein the payment processor is further operable to automatically credit at least one other user account in an amount corresponding to at least a portion of unused ones of the one or more first user credits.

11. The system of claim 9:
wherein the second payment comprises:
a first portion in exchange for hosting the second user account;
a second portion in exchange for one or more second user credits for online activity;
a third portion in exchange for one or more second user discounts for recruiting one or more third user accounts; and
a fourth portion for payment of at least one referral fee; and
wherein the payment processor is further operable to automatically credit at least one other user account in an amount corresponding to at least a portion of the referral fee.

12. The system of claim 9, wherein at least one first user credit is competition-specific.

13. The system of claim 9, wherein at least one first user discount is competition-specific.

14. The system of claim 9, wherein the payment processor operable to automatically credit at least one other user account in an amount corresponding to at least a portion of redeemed ones of the one or more first user discounts is further operable to automatically credit the first user account.

15. The system of claim 9, wherein the payment processor is further operable to:
determine a champion portion and a charity portion of a plurality of competition entry fees;
pay, after one or more rounds of a competition, the champion portion to a winning champion;
pay, after one or more rounds of a competition, the charity portion to one or more charities, wherein at least one of the one or more charities is selected by the winning champion.

16. The system of claim 9, wherein the payment processor is further operable to:
rank the user accounts based on online activity during a competition; and
select a winning user account based on the highest ranking one of the user accounts.

17. A non-transitory computer readable storage medium with an executable program for receiving and apportioning fees in an online environment comprising a plurality of user accounts stored thereon, wherein the executable program instructs a processor to perform the following steps:
receive, by a server, a first payment to register for a first user account comprising:
a first portion in exchange for hosting the first user account;
a second portion in exchange for one or more first user credits for online activity; and
a third portion in exchange for one or more first user discounts for recruiting one or more second user accounts;
receive, by the server, a second payment to register for a second user account; and
automatically credit at least one other user account in an amount corresponding to at least a portion of redeemed ones of the one or more first user discounts.

18. The non-transitory computer readable storage medium of claim 17, wherein the second payment comprises:
a first portion in exchange for hosting the second user account;
a second portion in exchange for one or more second user credits for online activity;
a third portion in exchange for one or more second user discounts for recruiting one or more third user accounts; and
a fourth portion for payment of at least one referral fee; and
wherein the payment processor is further operable to automatically credit at least one other user account in an amount corresponding to at least a portion of the referral fee.

19. The non-transitory computer readable storage medium of claim 17, wherein the program instructs a processor to perform the following additional steps:
determine a champion portion, an artist portion and a charity portion of a plurality of competition entry fees;
pay, after one or more rounds of a competition, the champion portion to a winning champion;
pay, after one or more rounds of a competition, the artist portion to a winning artist; and
pay, after one or more rounds of a competition, the charity portion to one or more charities, wherein at least one of the one or more charities is selected by the winning champion.

20. The non-transitory computer readable storage medium of claim 17, wherein the program instructs a processor to perform the following additional steps:
automatically credit at least one other user account in an amount corresponding to at least a portion of redeemed ones of the one or more first user discounts.
